(19) United States
(12) Patent Application Publication
(10) Pub. No.: US 2017/0073537 A1
(43) Pub. Date: Mar. 16, 2017

(54) SYSTEM AND METHOD FOR APPLICATION OF CHROMIC COMPOSITIONS

(71) Applicant: Cabela's Incorporated, Sidney, NE (US)

(72) Inventors: Guey (Ray) N. CHIN, Taipei (TW); Ev TARRELL, Sidney, NE (US)

(21) Appl. No.: 15/305,307

(22) PCT Filed: May 28, 2015
(86) PCT No.: PCT/US15/33035

§ 371 Date: Oct. 19, 2016

Related U.S. Application Data
(60) Provisional application No. 62/005,269, filed on May 30, 2014.

(51) Int. Cl. C09D 11/50; C09K 9/02; C09D 11/037

(52) U.S. Cl. CPC C09D 11/50; C09D 11/037; C09K 9/02; C09K 2211/1014; C09K 2211/1011; C09K 2211/1088; C09K 2211/1033

(57) ABSTRACT

The present disclosure provides a system and method for the application of chromic compounds. In one aspect, a printed material includes a surface and a first composition disposed on the surface. The first composition includes a chromic ink capable of transitioning from a first state to a second state. The chromic ink can undergo an irreversible molecular change in the presence of ultra-violet light at a first wavelength. The printed material further includes a second composition disposed on the surface and overlapping at least a portion of the first composition. The second composition includes a protectant capable of absorbing ultra-violet light at the first wavelength.

### CROSS-REFERENCE TO RELATED APPLICATIONS

This application claims priority to U.S. Provisional Appn. No. 62/005,269, filed May 30, 2014, which is incorporated by reference for all purposes.

### STATEMENT REGARDING FEDERALLY SPONSORED RESEARCH

Not applicable.

### BACKGROUND OF THE INVENTION

The disclosure relates, in general, to compounds and compositions exhibiting chromism and, more particularly, to the use of protectants in the application of chromic compositions.

Chromic materials (i.e., compounds or composition exhibiting chromism) include dyes and inks that may change chromic due to a change in the environment of the material. For example a photochromic material may change appearance following the application of certain wavelengths of light, while a thermochromic material may change appearance following the application of heat. Chromic materials have been applied to a variety of articles such as paper, writable media, textiles and so forth.

However, chromic materials may be adversely affected by exposure to various conditions associated with various uses of chromic materials, such as exposure to heat and sunlight. As a result, articles including chromic materials may have a limited lifetime. More generally, any article including one or more chromic materials may be adversely affected upon exposure to conditions such as heat, sunlight abrasion, solvents, surfactants and the like.

Therefore, a need exists for methods of mitigating the adverse effects of exposure of chromic materials to various conditions.

### SUMMARY OF THE INVENTION

The present invention overcomes the aforementioned drawbacks by providing a system and method for the application of chromic compositions.

In accordance with one aspect of the present disclosure, a printed material comprising a surface and an effective amount of a first composition disposed on the surface is provided. The first composition comprises a chromic ink capable of transitioning from a first state to a second state. In one embodiment, the chromic ink can undergo an irreversible molecular change in the presence of ultra-violet light at a first wavelength. The printed material further comprises an effective amount of a second composition disposed on the surface and overlapping at least a portion of the first composition. The second composition may comprise an effective amount of protectant capable of absorbing ultra-violet light at the first wavelength.

In accordance with another aspect of the present disclosure, a method comprising applying an effective amount of a first composition on a surface is provided. The first composition comprises a chromic ink capable of transitioning from a first state to a second state. The chromic ink can undergo an irreversible molecular change in the presence of ultra-violet light at a first wavelength. The method further comprises applying an effective amount of a second composition on the surface and overlapping with at least a portion of the first composition. The second composition may comprise an effective amount of a protectant capable of absorbing ultra-violet light at the first wavelength.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1A is an example structure of a cholesteric thermochromic liquid crystal;

FIG. 1B is an example structure of a molecule (bianthrone) that may exhibit thermochromism based on a transition between stereoisomers;

FIG. 1C is an example structure of a fluoran that may exhibit thermochromism;

FIG. 1D is an example structure of a fluoran derivative (crystal violet lactone) that may exhibit thermochromism;

FIG. 1E is an example structure of a spiropyran that may exhibit thermochromism;

FIG. 1F is an example structure of a fulgide that may exhibit thermochromism;

FIG. 2A is a molecular structure of 2-hydroxybenzophenone;

FIG. 2B is a molecular structure of a phenyl ester;

FIG. 2C is a molecular structure of cinnamic acid;

FIG. 2D is a molecular structure of a hydroxyphenylbenzotriazole;

FIG. 2E is an illustration of the amphoteric counterion behavior of a protectant having an “X-A-Y” structure in the presence of a chromic compound;

FIG. 3 is an example of a design including a camouflage pattern that may be applied to an article;

FIG. 4A is a schematic illustration of the application of compositions including chromic compounds and protectant to a leaf design;

FIG. 4B is a schematic illustration of a design including a non-chromic ink as applied to an article;

FIG. 4C is an illustration of a design including a chromic compound applied to the lead design of FIG. 4B;

FIG. 4D is an illustration of a design including a protectant as applied to the leaf design of FIG. 4C; and

FIG. 5 is an example method of providing an article including a chromic compound and a protectant according the present disclosure.

Like numbers will be used to describe like parts from Figure to Figure throughout the following detailed description.

### DETAILED DESCRIPTION OF THE INVENTION

The present invention is presented in several varying embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the system. One skilled in the relevant art will recognize, however, that the system and method may both be practiced without one or more of the specific details, or with other methods, components, materials, and so forth. In other instances, well-known structures, materials, or operations are not shown or described in detail to avoid obscuring aspects of the invention.

As also discussed above, in various situations it may be useful to provide an article comprising an effective amount of a chromic compound. By “chromic compound”, we mean any compound or composition that can exhibit chromism or participate in chromic phenomena, which generally results in an appearance (e.g., a color) of the compound changing from one state to another in response to a particular set of conditions. Chromic compounds, for example, may be incorporated into inks to create color-change inks. Chromic compounds may be characterized by any variety of chromism such as thermochromism, photochromism, electrochromism, solvatochrornism, cathodochromism and the like. The lifetime of many chromic compounds and compositions including chromic compounds can be adversely affected by exposure to various conditions including exposure to water, solvents, surfactants, abrasion, high and low temperatures, and radiation. For example, exposure to one or more of the aforementioned conditions may result in an irreversible change in the molecular structure of the molecules making up the chromic compound, thereby negating the chromic behavior of the molecule. Such a change may include decomposition, degradation, inter- or intramolecular reaction (e.g., polymerization), photofading, or another adverse effect that may affect the lifetime of the chromic compound.

By “effective amount”, we mean an amount of the chromic compound sufficient to effectively exhibit chromism or participate in chromic phenomena. In one embodiment, the effective amount comprises about 5 gm to about 25 gm chromic compound. In other embodiments, the effective amount of chromic compound ranges from about 1 gm to about 30 gms. In still other embodiments, the effective amount of chromic compound ranges from about 5 gm to about 10 gm.

In one aspect, effective amounts of the chromic materials may be applied for use in providing camouflage. Camouflage may be used in a number of ways to conceal the presence of an object or a person based on the color and design of a pattern. For example, camouflage may be utilized for hunting, fashion, military applications and for concealment in general. Typically, a particular camouflage pattern or design will be selected based on the context or environment in which the camouflage will be used. A camouflage design may include a representation of a natural structure or environment such as leaves, stems, branches or vegetative groupings of one or more bushes, trees, or the like.

One challenge is that a different pattern or camouflage design may be required depending on the season, weather, time of day, location and so forth. Accordingly, chromic materials have been employed to provide variable camouflage designs (see, for example, U.S. Pat. No. 5,985,381). However, chromic materials may be adversely affected by exposure to various conditions associated with the use of camouflage, such as exposure to heat and sunlight. As a result, camouflage articles including chromic materials may have a limited lifetime. More generally, any article including one or more chromic materials may be adversely affected upon exposure to conditions such as heat, sunlight abrasion, solvents, surfactants and the like. Therefore, there is a need for ways to mitigate the adverse effects of exposure of chromic materials to various conditions.

In order to improve the lifetime of a chromic compound, it may be useful to treat the article including the chromic compound with a protectant. For example, in the case of ultraviolet (UV) light, it may be useful to treat an article including a chromic compound with a protectant that absorbs, reflects or otherwise mitigates the adverse affects of the UV light. However, the treatment of an article with a composition including a protectant may increase the production cost of the article. In one aspect, the protectant may be applied at a dilute concentration in order to reduce the cost. However, the protectant may have a reduced efficacy at the dilute concentration. In another aspect, it may be useful to apply the protectant to the entirety of the article. For example, it may be useful to protect all of the surfaces of the article. Alternatively (or in addition), application of the protectant to the entirety of the article may comprise a more simplified method as compared to applying the protectant at specific locations on the article. However, this may in turn increase the expense due to the need for a greater amount of the protectant. Furthermore, chromic compounds, and in particular, chromic inks, are generally more expensive than similar non-chromic compounds. Therefore, it may be impractical to further increase the manufacturing cost of an article including a chromic compound by also applying a protectant to the entirety article. Various other problems may also arise as the scale, complexity, or other specifications of the article are varied.

Use of the disclosed article and method may address these and other issues. For example, an article may include a surface for receiving a first composition including a chromic compound. The chromic compound may be capable of transitioning from a first state to a second state. For instance, the chromic compound may be capable of changing color at temperatures ranging from about 2-4 degrees C.

AboutProductsColor ChartT RangeData Sheets (Matsui International Corp.-Chromicolor® Temperature Range Chart Regular Type)

| | | |
|---|---|---|
| | Color | Color |
| | Appears | Disappears |
| Temperature | Below | Above |

| Type | ° C. | ° F. | ° C. | ° F. |
|---|---|---|---|---|
| 5 | 1.0 | 33.8 | 12.0 | 53.6 |
| 10 | 8.0 | 46.4 | 16.0 | 60.8 |
| 15 | 11.0 | 51.8 | 19.0 | 66.2 |
| 17 | 14.0 | 57.2 | 23.0 | 73.4 |
| 20 | 16.0 | 60.8 | 26.0 | 78.8 |
| 25 | 22.0 | 71.6 | 31.0 | 87.8 |
| 27 | 24.0 | 75.2 | 33.0 | 91.4 |
| 35 | 27.0 | 80.6 | 36.0 | 96.8 |
| 37 | 32.0 | 89.6 | 41.0 | 105.8 |

** These types have some restrictions on minimum order quantity and color available. For example, in the first state the compound may be appear to be a first color or colorless, while in a second state the compound may appear to be a second color different from the first color, or colorless. In one particular example, the composition may transition from a yellow color to colorless (e.g., clear or transparent).

In some embodiments, the chromic compound and the first composition, in general, may be adversely affected by exposure to one or more conditions. For example, the first composition may be adversely affected by exposure to UV light. By “adversely affected” we mean that ultraviolet light breaks down and destroys the effectiveness of chromatic change effect and the color fastness of any prints including normal ink. In contrast, the presently claimed invention, when tested using the SGS Xenon Lamp test for color fastness and color changing ability, indicates that exposure to the Xenon Lamp (simulating Sunlight exposure/UV) lasts less than 10-15 hrs. After application of UV protector/inhibitor, the ink can last at least 80-100 hrs of exposure.

The adverse effects of the UV light may relate to the appearance of the first composition in the first state or the second state, or the ability of the chromic compound to transition between the first state and the second state. Other adverse effects may also be brought about as a result of exposure, including the color fastness of normal printed ink also affected by UV exposure besides Chromatic ink.

In order to mitigate the adverse effects, a second composition may be applied to the surface of the article. In one aspect, the second composition may be applied such that at least a portion of the second composition overlaps at least a portion of the first composition. The second composition may include a protectant capable of mitigating the affects of exposure of the first composition to the one or more conditions

For example, the protectant may be able to absorb UV light or stabilize the chromic compound in the presence of the UV light. In some embodiments, the chromic compound or the first composition in general may be affected by UV light at a specific wavelength or across a small or narrow range or band of wavelengths. Accordingly, the protectant may be selected to absorb UV light at the specific wavelength or across the band of wavelengths.

In some embodiments, a first composition including a chromic compound may be printed on an article such as a textile or garment. The first composition may be applied to the garment in a specific design or pattern such as by screen printing. Thereafter, a second composition including a protectant may be applied to the article. In some embodiments, the second composition including the protectant may be applied to the entirety or the majority of the article such as by dipping or soaking the article in the protectant (e.g., a bath of a mixture or solution including the protectant). In other embodiments, the amount of the second composition used may be reduced by applying the second composition only to a portion of the article as opposed to applying the composition to the entirety of the garment. For example, the second composition may be printed on the article using the same pattern or design as was used for application of the first composition.

In some embodiments, the protectant selected for the second composition may be tailored to complement the chromic compound or the first composition, in general. As described above, the protectant may be selected to absorb energy at a particular wavelength or across a narrow band of wavelengths that may adversely affect the first composition. The selection of a protectant based on the characteristics of the first composition may be useful where only a specific wavelength or narrow band of wavelengths adversely affects the first composition.

The selection of a specific protectant may also be useful in embodiments in which more than one composition is applied to the article. For example, two or more compositions including distinct chromic compound may be applied to an article. A first chromic compound may be applied in one design and a second composition may be applied in a second design over a different area of the article from the first design. Thereafter, two or more compositions including distinct protectants may be applied to the article. A first protectant having a first configuration may be applied to the design of the first chromic compound (i.e., overlapping the first chromic compound), while a second protectant having a second configuration may be applied to the article in the design of the second chromic compound (i.e., overlapping the second chromic compound).

Other combinations of chromic compounds and protectants are also within the scope of the present disclosure. For example, effective amounts of two or more protectants may be selected to mitigate the adverse affects of exposure of a single chromic compound or composition to a given condition. Similarly, effective amounts of a single protectant may be selected for use with effective amounts of two or more chromic compounds or compositions. By “effective amount” we mean an amount effective to yield the desired protective effect. In one embodiment, the effective amount ranges from about 15 gm to about 30 gm of each protectant. Other embodiments of the present disclosure will become apparent with reference to the figures and as further discussed herein.

The present disclosure may include the use of one or more compositions including one or more chromic compounds. A chromic compound may include any number of individual molecules or compositions where the chromic compound is capable of undergoing a color change. A color change may include a transition from a first color to a second color, a transition from a lighter tone to a darker tone, or a transition form a colorless, translucent, transparent or colored state to another of a colorless, translucent, transparent or colored state. Examples of chromic compounds may include thermochromic compounds and photochromic compounds. Thermochromic compounds may include compounds or compositions that undergo a transition as a result of a change in temperature, while photochromic compounds or compositions may include compounds or compositions that undergo a transition as a result of exposure to light radiation. In some embodiments, the transition may be either reversible or irreversible.

With respect to thermochromic compounds, while several varieties of thermochromic systems are known, such as transition metal systems, organometallic systems and organic systems, the most commonly applied thermochromic compounds are selected from the latter class of molecules (i.e., the organic systems). In one aspect, organic thermochromic compounds may be divided into thermochromic liquid crystals (TLC) and leuco dyes as each of these classes of molecules may undergo a transition at or near room temperature. Moreover, each of these classes of thermochromic molecules may be suitably applied to articles such as textiles, garments and the like.

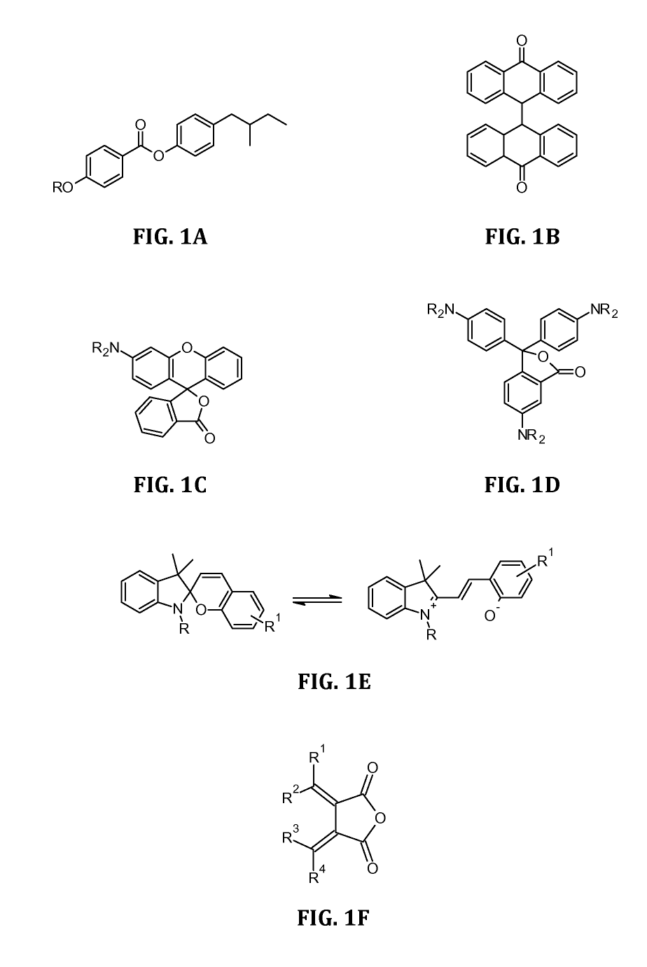

TLC may occupy stable nematic, smectic and cholesteric thermotropic mesophases with the latter being the most commonly employed for the application of TLC as ink compositions. The TLC compound may be microencapsulated and combined with a suitable resin or binder in order to stably apply the TLC to the article. However, these molecules are typically more expensive than leuco dyes and may further be less vivid as compared with leuco dyes. FIG. 1A shows one example of a TLC compound where R represents a variable substituent.

While other organic thermochromic systems exist such as thermochromic compounds where the transition may be the result of stereoisomerism such as in the case of bianthrone (FIG. 1B), this use of leuco dyes has been suitably employed in the art for application to textiles and garments. Suitable leuco dye systems that may be used in embodiments of the present disclosure include spirolactone dyes including fluorans (FIG. 1C) and derivatives of crystal violet lactone (FIG. 1D), spiropyrans (FIG. 1E) and fulgides (FIG. 1F). The use of R, R1, and so forth is used to represent a variable substituent such as in FIGS. 1C-1F. For example, Matsui International Corp.'s AQ Ink (Water Based) and Gravure Ink (Oil Based) may be effective here.

Leuco dye compositions may include chromic compounds that undergo a transition between two structural isomers of the molecule. This behavior is known as tautomerism and may include transitions of a molecule between a keto and enol form, between a lactam and lactim ring, between an amide and an amidic acid, between and amine and an imine, and the like. The shift in equilibrium between the two tautomeric forms of the molecule may be the result of a change in temperature. However, for compositions including a leuco dye, a change in the polarity or pH of the environment around the chromic compound may also affect the equilibrium between the tautomeric forms. As described by Aitken et al., a transition effected by a change in pH is more correctly described as halochromism (Aitken et al., 1996, Rev. Prog. Coloration, vol. 26, pp. 1-8). However, the pH of a solvent included in a composition including the leuco dye may be temperature-dependent, thereby resulting in an overall thermochromic behavior of the system.

In one aspect, a leuco dye may exhibit a reversible thermochromic behavior. For example, in the case of a system including crystal violet lactone (FIG. 1D; R=Methyl), the molecule may inhabit a first, colorless state when the molecule is deprotonated in the lactone form. However, when the environment around the molecules changes, for example due to a temperature or pH change, the molecule may transition to a second, colorful state in which the molecule is protonated.

Depending on how a composition or system including the molecule is formulated, the transition between the first state and the second state may be reversible. For example, a chromic compound may be combined with an appropriate solvent and a color developer. In general, a solvent may include an organic hydrophobic composition such as an aliphatic alcohol having between eight and eighteen carbon atoms. The solvent may be selected based on the application and the nature of the chromic compound, and many solvents have been described in art including (see, for example, Aitken et al.).

Color developers used in the formulation of chromic compositions have been described as catalysts, proton donors and electron acceptors. The exact mechanism by which the color developer acts may vary between systems and, in many cases, is not well understood. However, the color developer is generally a weakly acidic compound such as a phenol derivative. Other color developers have been documented elsewhere (see, for example, Aitken et al.).

In some embodiments, the chromic compound may be coencapsulated with the color developer and the hydrophobic solvent, such as by microencapsulation with a polymeric coating. In general, the polymeric coating may be selected to be impermeable to the chromic composition. Moreover, the contents of the microcapsule should be visible. Accordingly, the polymer may be translucent or transparent to visible light. Microencapsulation may be useful to control the environment of a chromic compound while simultaneously enabling the chromic compound to be applied to an article. Microencapsulation techniques are generally known in the art and may include coacervation, interfacial polymerization and the like to provide microcapsules in the range of about 50 μm to about 2000 μm. Other sizes of microcapsules and, more broadly, other techniques may be used to prepare a chromic composition for application to an article.

Following the formation of a chromic composition, which may include microencapsulation of a chromic compound with a color developer and a solvent, the chromic composition may be prepared for application to a suitable article. In one aspect, it may be useful to combine the chromic composition with an acrylic printing paste or another suitable binder material to facilitate adherence of the chromic composition to the article. In another aspect, a composition for printing or applying a chromic composition to an article may comprise about 1% of the chromic compound. The first composition including the chromic compound may be printed using a screen printing technique. Accordingly, the composition may be cured after printing in order to more permanently adhere the composition to the article.

In some embodiments, after applying a chromic compound or composition to an article, no additional steps may be required to prepare the article for use. However, as described previously, a chromic compound may be adversely affected by exposure to one or more conditions. For an article such as a garment that may be washed or exposed to sunlight, exposure to a known adverse condition may be likely. Therefore, it may be useful to improve the lifetime of the chromic compound by treating the compound, and more generally, the article with a composition including a protectant.

In one aspect, it may be useful to include a protectant that is selected based on a particular application. For example, an article that may be exposed to surfactants may include a protectant that can mitigate the adverse effects of a surfactant. In another example, an article that may be exposed to abrasion may include a protectant such as a low friction coating that may be used to mitigate the adverse effects of exposure to abrasion. In yet another example, an article that may be exposed to natural light or another source of UV light may be treated with a protectant that can, for example convert the UV light into heat energy or another form of energy, stabilize or otherwise protect a molecule when exposed to UV light.

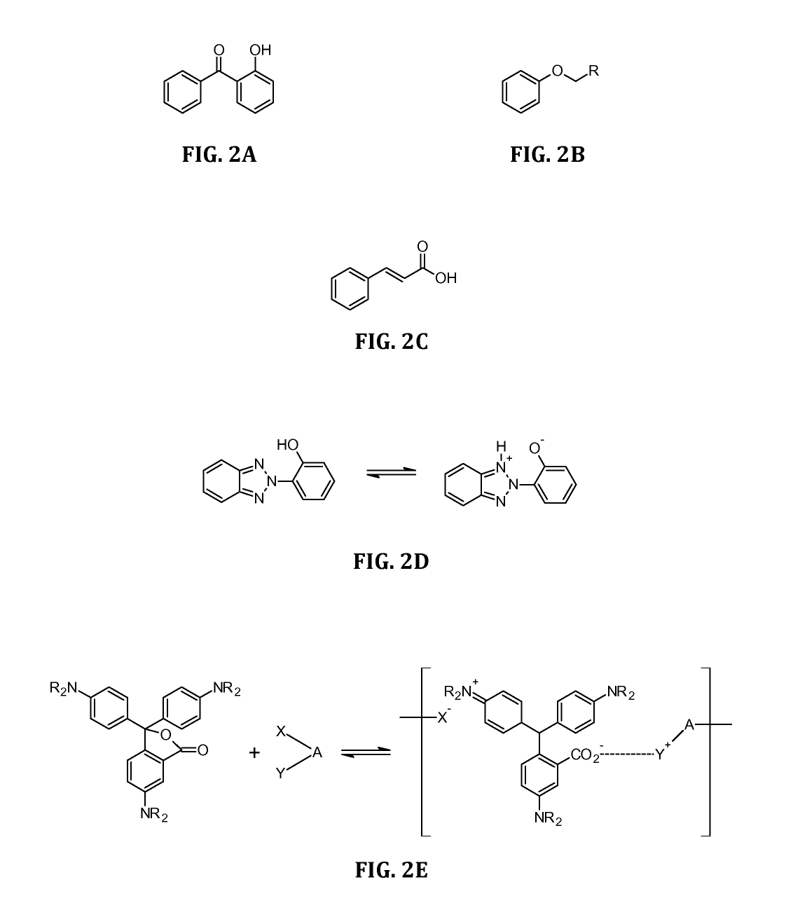

With respect to UV light, a number of protectants exist for use in clothing such as benzotriazole derivatives marketed under the name Tinosorb. However, other classes of protectant compounds may be selected for the treatment of articles including chromic compositions. Examples of protectants suitable for mitigating exposure of a chromic compound to UV light may include derivatives of 2-hydroxybenzophenone (FIG. 2A), phenyl esters (FIG. 2B), derivatives of cinnamic acid (FIG. 2C), and hydroxyphenylbenzotriazoles (FIG. 2D). As described by Oda, molecules such as shown in FIG. 2D and derivatives thereof may mitigate the adverse effects of UV light by absorbing UV radiation and converting it into heat energy by means of rapid tautomerism (Oda, H., 2008, Dyes and Pigments, vol. 76, pp. 270-276). Other mechanisms by which a protectant may mitigate the effects of UV light include reflecting the UV light, absorbing the UV light at a first wavelength and reemitting light at a second, different wavelength (e.g., fluorescence) or by stabilizing the chromic compound. In one aspect, a protectant may act as an amphoteric counter ion by forming a complex with one or more states of a chromic compound.

As further described by Oda, and with reference to FIG. 2E, a UV protectant (X) may include a UV absorbing core (A), a moiety capable of maintaining a positive charge (Y), and a moiety capable of maintaining a negative charge (X). Examples of protectants having an “X-A-Y” structure as shown in FIG. 2E may include hydroxyphenylbenzyltriazole and 5-(2-benzotriazolyl)-2,4-dihydroxybenzoate. In one aspect, a carboxylic acid group may be associated with a proton or a metal salt such as a zinc salt or a nickel salt. In the case of a proton, the UV protectant may not be able to function as an amphoteric counterion to a chromic compound. However, metal salts of the UV protectant may function as an amphoteric counterion to a chromic die containing a lactone ring, such as crystal violet lactone, and derivatives thereof. Other suitable protectant molecules may also be used to protect a chromic compound against photofading, improve light fastness, and mitigate the effects of exposure of a chromic compound to UV light in general.

In some embodiments, it may be determined that a particular wavelength or band of wavelengths has an adverse effect on a given chromic compound. This may be determined using any method known to one of skill in the art that measures the ability for color changing at specific temperatures. Ultraviolet light may include wavelengths between about 400 nm and about 100 nm. However, it may be determined that a given chromic compound or composition is adversely affected by 210 nm light. In another aspect, a chromic compound or composition may be adversely affected by small or narrow band of wavelengths between about 200 nm and about 220 nm. Accordingly, a protectant compound or composition may be able to preferentially absorb UV light at about 210 nm or between about 200 nm to about 220 nm. The use of a tailored protectant may increase the lifetime of the chromic compound as compared with a protectant that absorbs light across a large range of wavelengths. Moreover, it may be possible to use a lower concentration of the tailored UV protectant due to the increased specificity of the protectant for the wavelength of narrow band of wavelengths that affect the chromic compound.

In another aspect, effective amounts of multiple chromic compounds or compositions may be applied to an article. For example, a first chromic compound may be applied to an article in a first location and a second chromic compound may be applied to a garment in a second location. The first chromic compound may be adversely affected by a first UV wavelength or band of wavelengths, while the second chromic compound may be adversely affected by a second UV wavelength or band of wavelengths. Accordingly, a first protectant may be selected based on the first chromic compound while a second protectant may be selected based on the second chromic compound. In one aspect, the first protectant may only be applied to the article at the first location and the second protectant may only be applied at the second location. The application of a protectant only in the location of the corresponding chromic compound may reduce the total overall amount of protectant needed to treat an article as compared with coating the entire article with the protectant.

In another aspect, effective amounts of multiple protectants may be applied to an article in combination with effective amounts of at least one chromic compound. For example, a chromic compound may be adversely affected by two distinct UV wavelengths or two distinct small or narrow bands of UV wavelengths. For example, a chromic compound may be susceptible to UV light at both 120 nm and 340 nm. In order to provide protection to the chromic compound, two distinct protectants may be selected with a first of the protectants being able to absorb UV light at 120 nm and the second of the protectants being able to absorb UV light at 340 nm. Alternatively, or in addition, it may be possible to select a UV protectant that is configured to absorb light at both about 120 nm and about 340 nm. If two or more protectants are selected, the protectants may be applied separately or simultaneously. For example, the protectants may be combined in a single composition and applied to the article, or the protectants may be formulated as distinct compositions which may be applied sequentially to the article.

Various methods may be used to apply one or more chromic compositions and protectant compositions to an article. For example, the chromic compound may be brushed, sprayed, printed such as with an ink-jet printer, silk-screened, or otherwise applied to a surface of an article. Alternatively (or in addition), the chromic compound may be incorporated into the article. For example, a chromic compound may be incorporated into a fiber that may then be woven into a textile or used to form another article.

With respect to screen printing, a screen printing apparatus may generally include a platform for locating an article to be printed. Suitable articles may include paper, canvas, textiles, garments such as T-shirts, sweatshirts, pants, hats, other garments, and fabrics in general. In order to apply an ink or another composition to the article, a screen may be placed over the article and the ink may be transferred to the article through the screen such as with the use of a squeegee or other instrument. In general, a screen may be characterized by a particular mesh size that may be varied depending on factors such as the characteristics of the article and the compositions being printed. Mesh size may be measured by the number of threads per unit area with higher mesh counts generally resulting in a finer mesh. For example, a 100 mesh screen has 100 threads crossing per square inch. In some embodiments, a higher mesh size may be used with a composition having a lower viscosity or a slurry having a smaller particle size. By comparison, a lower mesh size may be used with a composition or a slurry having a higher viscosity or a larger particle size.

In one aspect a screen may include a design such that when a composition is transferred through the screen to the article, the design (or the inverse of the design) is transferred to the article. In one aspect, multiple compositions may be applied to the article using the same screen or different screens. However, it may it may be useful to cure a first composition after it is applied to the article before a second composition is applied to the article. Curing may include allowing the composition to become more permanently associated with the article. A step of curing may include exposure of a composition to heat, light (e.g., UV light), or allowing the article including the composition to rest in order for volatile compounds to evaporate from the applied composition.

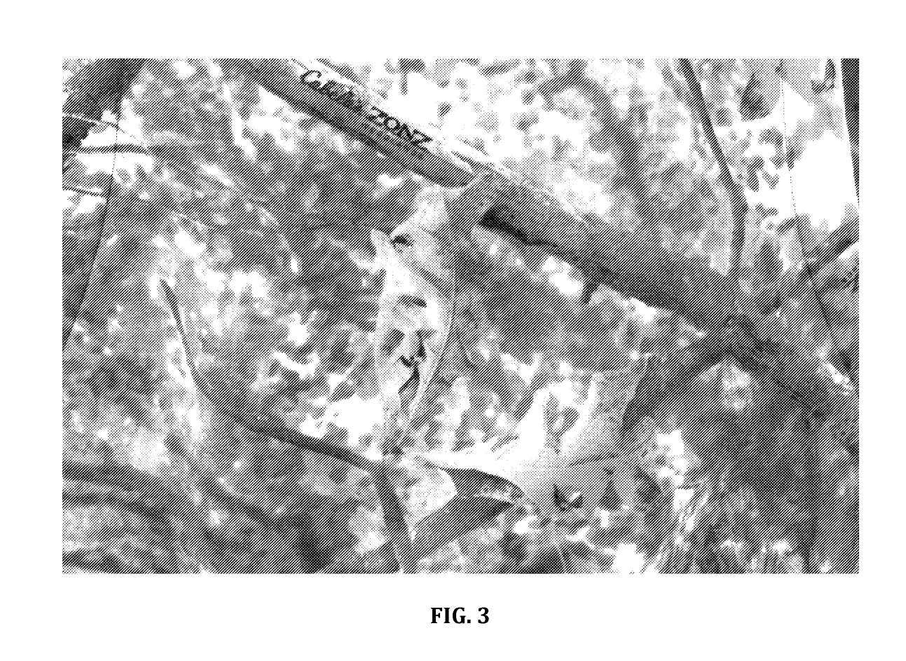

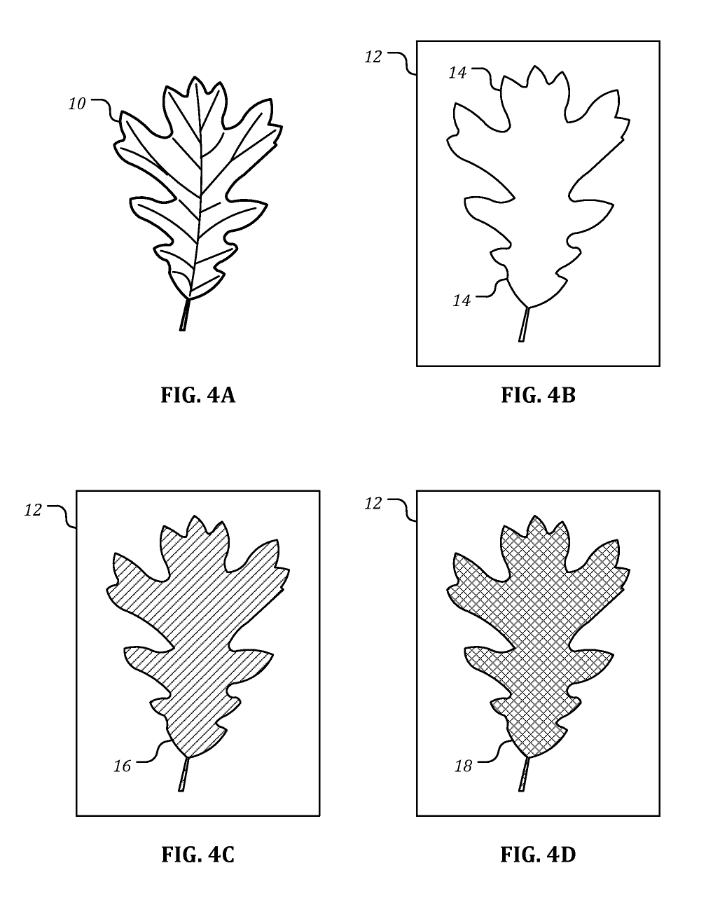

In some embodiments, an article may be prepared including both chromic and non-chromic inks. For example, a camouflage design as shown in FIG. 3 may be applied to a garment or another article. The camouflage design may include an image of trees, grasses, leaves and the like. The design may be initially applied to the article using one or more non-chromic inks. As shown in FIG. 4A, it may be useful to provide a design including a leaf 10. At least a portion of the design of leaf 10 may be printed on an article 12 using a non-chromic ink composition. The design 14, as shown in FIG. 4B, may have the general appearance of the leaf 10. However, the leaf design may not include a chromic compound and therefore may not exhibit chromism.

Thereafter, a chromic composition may be applied using a silk screen to a portion of the design 14. For example, an effective amount of a first composition comprising an effective amount of a chromic compound may be applied only to the portions of the article 12 where the leaf design 14 was previously applied. The resulting design 16 as shown in FIG. 4C, may include the first composition and the non-chromic ink. The first composition may be cured and an effective amount of a second composition comprising an effective amount of a protectant selected based on the chromic compound may be applied to the article 12. In one aspect, the protectant may be applied to the article 12 using the same silk screen in order to apply the protectant only to the portions of the article 12 where the leaf design 16 including the first composition was previously applied. The resulting design 18 as shown in FIG. 4D may include the first composition, the second composition and the non-chromic ink. The second composition may be cured, and thereafter the article may be worn or otherwise employed by a user. It should be noted that one or more steps as described in the previous example may be carried out in an alternative order. Moreover, additional steps may be added while other steps may be omitted. It will also be appreciated that any design may be applied to an article and the present disclosure is not meant to be limited to the application of camouflage designs to garments.

The resulting article including the camouflage design may appear differently based on the temperature of the article. For example, at lower temperature, such as at about 25° C., the chromic compounds may be colorless and the camouflage design may appear to show an autumnal scene including various brown tones. However, as the temperature of the article increases, such as to about 32° C., the chromic compound may transition from the first, colorless state to a second, colorful state. In one aspect, the chromic composition may have a green or yellow appearance at the higher temperature. Accordingly, the camouflage design may appear to show a spring or summer scene including various green and yellow tones.

The camouflage design, once printed can be incorporated into various articles or garments. In additional to incorporating chromic materials and corresponding attributes, the camouflage design may incorporate other features or design attributes arranged to enhance the effectiveness of the camouflage design. For example, the chromic elements, once printed may be utilized to depict one or more elements commonly found within a particular hunting environment. The element may involve, for example, depictions of plants or parts of plants commonly found within the hunting environment. Some camouflage design may include depictions of a number of different elements found in different microterrains within a larger hunting environment. For example, when designing a camouflage pattern for a hunting terrain in which waterfowl are commonly found, the microterrains may include grassy areas, water areas, and tree-lined areas. To generate a camouflage design for that hunting environment, then, elements could be selected from each of those microterrains and depictions of each element selected from the microterrains could be incorporated into the camouflage design.

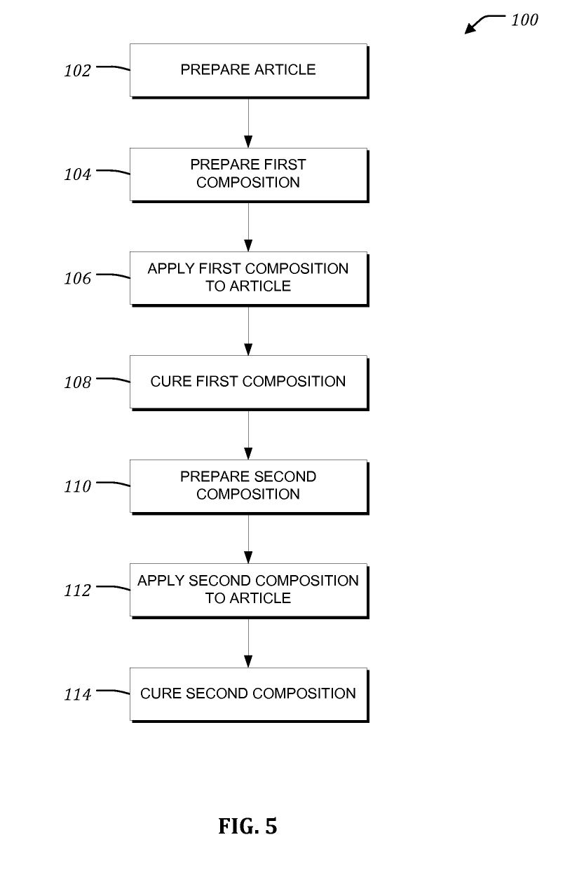

A general method that may be used to prepare an article with at least one chromic composition and one protectant selected based on the properties of the chromic composition is shown in FIG. 5. A method 100 may include a first step 102 in which an article is prepared to receive one or more compositions. Step 102 may include applying a first pattern to an article using non-chromic inks as described herein. Alternatively (or in addition), step 102 may include washing the article, treating the article with a sizing material, arranging or positioning the article, preparing a surface of the article, or any other step that may be required to prepare the article for subsequent steps of the method 100. In a next step 104 of the method 100, a first composition may be prepared. The first composition may include a chromic compound. The first composition may further include one or more additional components such as a color developer or solvent as described herein. In some embodiments, a step 104 may include a microencapsulation step or another formulation step in which the chromic compound is combined with a binder, a resin or another suitable composition for application of the chromic compound to the article.

A next step 106 of the method 100 may include applying the first composition. The first composition may be applied using any suitable application or printing technique such as screen printing. Following step 106, a next step 108 of the method 100 may include curing the first composition. As with each of the steps of the method 100, a step 108 may be omitted where curing is not required. However, it may be useful to expose the first composition and the article to a light source or a heat source, or allow the article to rest in order to improve the adherence of the first composition to the article. A step 108 may additionally (or alternatively) include preparing the article including the first composition to receive a second composition in a next step 110 of the method 100.

In a step 110, a second composition may be prepared including a protectant. In one aspect, the protectant may be selected based on the characteristics of the first composition or the chromic compound included in the first composition. As discussed previously, the chromic compound may be adversely affected by exposure to one or more conditions such as UV light. Accordingly, the protectant may be selected to mitigate the effects of exposure, such as by absorbing or transforming UV light. Preparation of the second composition in step 110 may include combining the protectant with a binder, resin, or other compound or composition in order to achieve application of the second composition to the article. For example, a protectant may be combined with a binder to provide a slurry. In one aspect, the slurry may include about 0.1% to about 50% of a protectant by weight. In another aspect, the slurry may include about 1% to about 15% of a protectant by weight. In yet another aspect, the slurry may include about 5% to about 10% of a protectant by weight.

A step 112 of the method 100 may include application of the second composition to the article. As in the case of step 106 of the method 100, step 112 may include application of the second composition using any suitable method or printing technique such as screen printing. In some embodiments, the article may be dipped into or soaked in a solution including the second composition. Following step 112, a next step 114 of the method 100 may include curing the second composition. It may be useful to expose the second composition and the article to a light source or a heat source, or allow the article to rest in order to improve the adherence of the second composition to the article. In some embodiments, a step 108 of the method 100 may be omitted, and the step 114 may include curing both the first composition and second composition simultaneously. A step 114 may additionally (or alternatively) include preparing the article including the first and second compositions to receive additional compositions that may include chromic compounds or protectants.

The schematic flow chart shown in FIG. 5 is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed in FIG. 5 are provided to explain the logical steps of the method and are understood not to limit the scope of the method. Although various arrow types and line types may be employed, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Each reference identified in the present application is herein incorporated by reference in its entirety.

What is claimed is:

1. A printed material, comprising:
a surface;
an effective amount of a first composition disposed on the surface, the first composition comprising an effective amount of a chromic ink capable of transitioning from a first state to a second state; and
an effective amount of a second composition disposed on at least a portion of the surface and overlapping at least a portion of the first composition.

2. The printed material of claim 1, wherein the chromic ink undergoes an irreversible molecular change in the presence of ultra-violet light at a first wavelength.

3. The printed material of claim 1, wherein the second composition includes an effective amount of a protectant capable of absorbing ultra-violet light at the first wavelength.

4. The printed material of claim 1, wherein the protectant only absorbs ultra-violet light at about the first wavelength.

5. The printed material of claim 1, wherein an effective amount of the first composition is disposed on at least a portion of the surface in a first pattern, and wherein an effective amount of the second composition is disposed on at least a portion of the surface in the first pattern.

6. The printed material of claim 1, wherein an effective amount of the first composition is screen printed on to at least a portion of the surface.

7. The printed material of claim 1, wherein the second composition comprises about 5% to about 10% of the protectant.

8. A method, comprising:
applying an effective amount of a first composition on a surface, the first composition including an effective amount of a chromic ink capable of transitioning from a first state to a second state; and
applying an effective amount of a second composition on the surface and overlapping with at least a portion of the first composition.

9. The method of claim 8, wherein the chromic ink undergoes an irreversible molecular change in the presence of ultra-violet light at a first wavelength.

10. The method of claim 8, wherein the second composition comprises an effective amount of a protectant capable of absorbing ultra-violet light at the first wavelength.

11. The method of claim 8, wherein the protectant only absorbs ultra-violet light at about the first wavelength.

12. The method of claim 8, wherein an effective amount of the first composition is applied to at least a portion of the surface in a first pattern, and wherein an effective amount of the second composition is applied to at least a portion of the surface in the first pattern.

13. The method of claim 8, wherein the step of applying the first composition comprises screen printing.

14. The method of claim 8, wherein the second composition comprises about 5% to about 10% of the protectant.

15. The method of claim 8, wherein the surface comprises at least a portion of a camouflage garment and the first composition forms at least a portion of a camouflage pattern of the camouflage garment.

16. The method of claim 15, wherein the camouflage pattern depicts elements selected from a number of microterrains within a hunting environment.

17. A printed material, comprising:
a surface;
an effective amount of a first composition disposed on the surface, the first composition comprising an effective amount of a chromic ink capable of transitioning from a first state to a second state, the chromic ink undergoing an irreversible molecular change in the presence of ultra-violet light at a first wavelength; and
an effective amount of a second composition disposed on the surface and overlapping at least a portion of the first composition, the second composition comprising an effective amount of a protectant capable of absorbing ultra-violet light at the first wavelength.

18. The printed material of claim 17, wherein the protectant only absorbs ultra-violet light at about the first wavelength.

19. The printed material of claim 17, wherein the first composition is disposed on at least a portion of the surface in a first pattern, and wherein the second composition is disposed on at least a portion of the surface in the first pattern.

20. The printed material of claim 17, wherein the second composition comprises about 5% to about 10% of the protectant.
